(19) United States
(12) Patent Application Publication
(10) Pub. No.: US 2010/0010801 A1
(43) Pub. Date: Jan. 14, 2010

(54) CONFLICT RESOLUTION AND ERROR RECOVERY STRATEGIES

(75) Inventors: Henricus Johannes Maria Meijer, Mercer Island, WA (US); John Wesley Dyer, Monroe, WA (US); Thomas Meschter, Renton, WA (US); Cyrus Najmabadi, New York, NY (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/171,929

(22) Filed: Jul. 11, 2008

(51) Int. Cl. G06F 17/27

(52) U.S. Cl. 704/9

(57) ABSTRACT

A plethora of strategies is afforded to facilitate conflict resolution and error recovery with respect to parsing, among other things. Grammar authors can select amongst a range of strategies or options on a case-by-case basis to address conflicts, ambiguities, errors, and the like. The strategies can be either static or dynamic. In one instance, code external to a parsing system can be invoked to resolve conflicts or recover from errors, and further enable change of strategy without requiring modification of the parser. Interaction between the parsing system and the external code can also be formalized to ensure general type safety of the system.

### BACKGROUND

A programmer utilizing a programming language creates the instructions comprising a computer program. Typically, source code is specified or edited by a programmer manually and/or with help of an integrated development environment (IDE) comprising numerous development services (e.g., editor, debugger, auto fill, intelligent assistance . . . ). By way of example, a programmer may choose to implement source code utilizing an object-oriented programming language (e.g., C#, VB, Java . . . ) where programmatic logic is specified as interactions between instances of classes or objects, among other things. Subsequently, the source code can be compiled or otherwise transformed to another form to facilitate execution by a computer or like device.

A compiler conventionally produces code for a specific target from source code. For example, some compilers transform source code into native code for execution by a specific machine. Other compilers generate intermediate code from source code, where this intermediate code is subsequently interpreted dynamically at run time or compiled just-in-time (JIT) to facilitate execution across computer platforms, for instance. Further yet, some compilers are utilized by IDEs to perform background compilation to aid programmers by identifying actual or potential problems, among other things.

In general, compilers perform syntactic and semantic program analysis. Syntactic analysis involves verification of program syntax. In particular, a program is lexically analyzed to produce tokens, and these tokens are parsed into syntax trees (or some other representation internal to the compiler) as a function of a programming language grammar. Typically, a parse tree is constructed during this compilation phase. A parse tree is made up of several nodes and branches where interior nodes correspond to non-terminals of the grammar and leaves correspond to terminals. The parse tree is subsequently employed to perform semantic analysis, which concerns determining and analyzing the meaning of a program.

Syntactic analysis or tree generation is performed by a parser or parse system. Parsers enable programs to either recognize or transcribe patterns matching formal grammars. A parser can be written by hand or by feeding a formal specification of a language grammar into a parser generator, which in turn produces necessary code.

It is desirable to write language grammars in a way that is natural for humans to read. Unfortunately, this means there are often ambiguities in the grammar or places where the generated parser cannot tell, based on the grammar alone, which grammar rule should be processed. Consider the following classic example of an ambiguous grammar: “S→if E then S else S|if E then S”. The parser generated from this grammar will not be able to process the input “if a then if b then s1 else s2”, because that parser cannot determine based on the grammar alone if the “else” belongs to the first “if” or the second. Furthermore, it might even be the case that a grammar is inherently ambiguous, for instance determining in certain situations if an identifier denotes a type or a variable.

Conventional systems require a user to rewrite the grammar to eliminate the ambiguity thereby producing a grammar that is harder to read than the original. Alternatively, a fixed set of static strategies can be employed that handle ambiguities in a pre-determined manner. For instance, a notation can exist with respect to the grammar to indicate that the “else” in the previous example is always associated with either the first or second “if.”

Error recovery in existing systems operates similarly. Either the system employs no error recovery, employs a fixed set of strategies that handle errors in a pre-determined manner, or requires changes to the grammar specification that alters the language understood by the resulting parser. Further, sometimes programmers may need to tweak the generated parse code by hand.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to language and/or data processing in light of various conflicts, ambiguities, and/or errors. Although not limited thereto, in one embodiment, processing refers to parsing and parser system generation. A variety of strategies or options are available to grammar authors for handling conflicts or ambiguities and errors including conventional static strategies as well as strategies that are more dynamic. In accordance with one aspect of the disclosure, a strategy can invoke code, a service, or a process external to a parsing system, for example. In this manner, an implementation of a conflict resolution or error recovery strategy can be changed without altering the parser or parser specification (e.g., the grammar). Further, various mechanisms can be employed to control the interaction between a system and external or outside code to ensure general type safety. Other strategies can also employ similar mechanisms with like results including one that employs a parser itself to explore potential actions and/or one that swaps parsers to resolve conflicts or ambiguities and/or recover from errors.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a parser generation system capable of resolving conflicts in accordance with an aspect of the disclosure.

FIG. 2 is a block diagram of a representative strategy component according to an aspect of the subject disclosure.

FIG. 3a is a block diagram of a representative static strategy component according to a disclosed aspect.

FIG. 3b is a block diagram of a representative dynamic strategy component in accordance with an aspect of the disclosed subject matter.

FIG. 4 is a block diagram of a system employing a code invocation strategy in accordance with an aspect of the disclosure.

FIG. 5 is a block diagram of a parse system according to a disclosed aspect.

FIG. 6 is a block diagram of a parser generation system that includes error recovery strategies in accordance with a disclosed aspect.

FIG. 7 is a block diagram of a strategy selection system according to an aspect of the disclosure.

FIG. 8 is a flow chart diagram of a parser generation method in accordance with a disclosed aspect.

FIG. 9 is a flow chart diagram of a method of code processing in accordance with an aspect of the disclosure.

FIG. 10 is a flow chart diagram of a method of safe issue resolution employing external code in accordance with an aspect of the disclosure.

FIG. 11 is a flow chart diagram of an external code/service for issue resolution.

FIG. 12 is a flow chart diagram of a conflict resolution method that explores potential actions to identify the best in accordance with an aspect of the disclosure.

FIG. 13 is a flow chart diagram of a conflict resolution method that swaps parsers in accordance with a disclosed aspect.

FIG. 14 is a schematic block diagram illustrating a suitable operating environment for aspects of the subject disclosure.

FIG. 15 is a schematic block diagram of a sample-computing environment.

### DETAILED DESCRIPTION

Systems and methods pertaining to conflict resolution and error recovery, among other things, are described in detail hereinafter. Numerous static and dynamic strategies are available for handling conflicts, ambiguities, errors, and the like. Grammar authors can specify such strategies with respect to a grammar rather than constructing a more convoluted grammar addressing issues such as conflicts and errors. In accordance with one aspect, a generated parser can be directed to external resolution or recovery code that enables a change of strategy or implementation thereof without altering the parser or grammar from which the parser is generated. Further, interactions between the parser and code can be formalized to prevent undesirable or erroneous parser behavior.

Various aspects of the subject disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

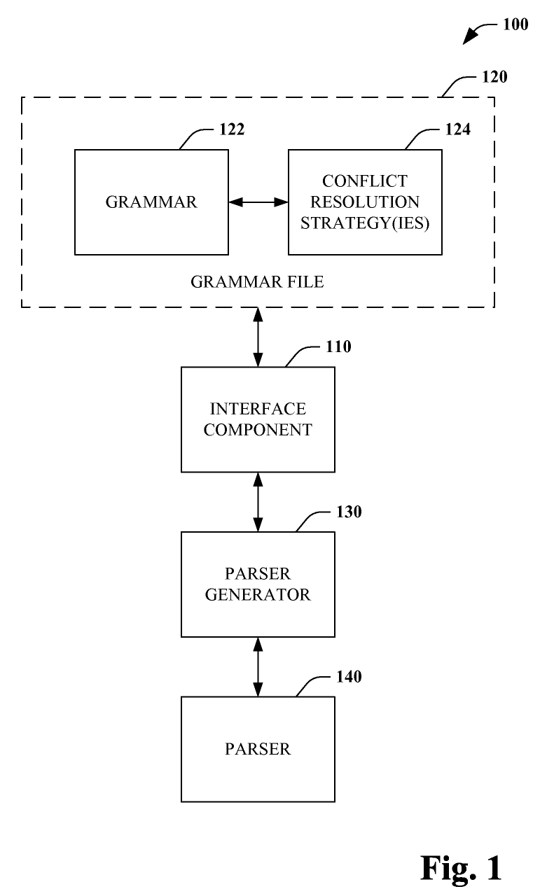

Referring initially to FIG. 1, a parser generation system 100 is illustrated in accordance with an aspect of the claimed subject matter. As shown, the system 100 includes an interface component 110 that facilitates interaction between a grammar file 120 and a parser generator 130 (also component as defined herein). From the grammar file 120, the parser generator 130 can produce a parser 140 capable of recognizing and/or transcribing patterns matching a formal grammar or specification 122. The parser 140 can then be utilized as part of a compiler to aid program development in an integrated development environment (IDE), or transform code format from source to target, among other things.

It is desirable to specify grammars in a natural, easy to read form. This allows interested individuals to read a specification and understand a described language, which is particularly helpful for specification drafting and testing, for example. Otherwise, it is unclear what programs a parser and its associated grammar recognizes. Conventional hand-written parsers, including most industrial compilers, are a classic example of a lack of clarity since a variety of other code is included and added in an ad hoc manner resulting in a very convoluted code base. Parser generation systems are a bit better in this regard, as they force specification of a formal grammar. Nevertheless, the most natural way of describing languages often include grammatical ambiguities or conflicts. While grammars can sometimes be rewritten to exclude the ambiguities, this generally makes grammars harder to read. Alternatively, a set of one or more strategies 124 (a component as described herein) can be coupled with a grammar 122 (also a component as described herein) to resolve conflicts.

Conventionally, a set of fixed and/or static strategies is available to address ambiguities in a pre-determined manner. Consider, again, the standard example of an ambiguous grammar: “S→if E then S else S|if E then S”. The parser 140 generated from this grammar will not be able to process the input “if a then if b then s1else s2”, because that parser cannot determine based on the grammar alone if the “else” belongs to the first “if” or the second. This classic shift-reduce conflict can be addressed by a strategy that indicates that the “else” is always associated with the first or second “if.” This corresponds to a static rule that once captured in a parser 140 via parser generator 130 cannot be changed without altering the parser 140. Furthermore, the limited set of strategies 124 is not necessarily effective across all languages and language constructs.

In accordance with one aspect of the claimed subject matter, a wide range of strategies or options can be provided and made available to grammar authors to facilitate conflict and/or ambiguity resolution, among other things. Further yet, multiple strategies can be associated with a particular conflict or ambiguity to ensure resolution, to an extent, should other strategies fail. In one implementation, a unique name can be generated for each conflict as a function of grammar rules involved, and the author can specify in the grammar file 120 what strategy to use for each conflict. With respect to the example above, an author can specify that a “shift” should be chosen rather than a “reduce” by adding a command such as the following: “% OnConflict ShiftElseKeyword, ReduceIfStatement Prefer ShiftElseKeyword”. Here, the command identifies the two available conflicting options and indicates a preference for one.

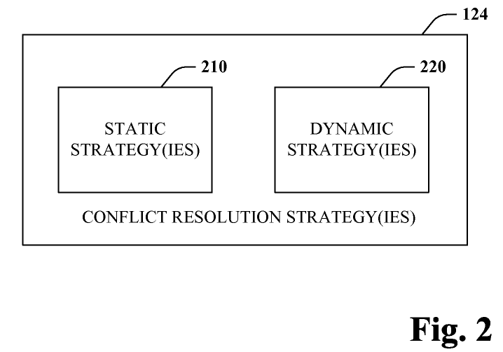

Turning attention to FIG. 2, a representative conflict resolution strategy(ies) component 124 is depicted in accordance an aspect of the claimed subject matter. Strategies can either be either static or dynamic as depicted by components 210 and 220. Static strategies 210 refer to specific conflict resolutions, rules or the like that function in a predetermined manner including but not limited to those known in the art. Conversely, dynamic strategies 220 refer to strategies in which resolutions and/or functionality associated therewith is known only at runtime or is dependent upon execution and/or runtime context.

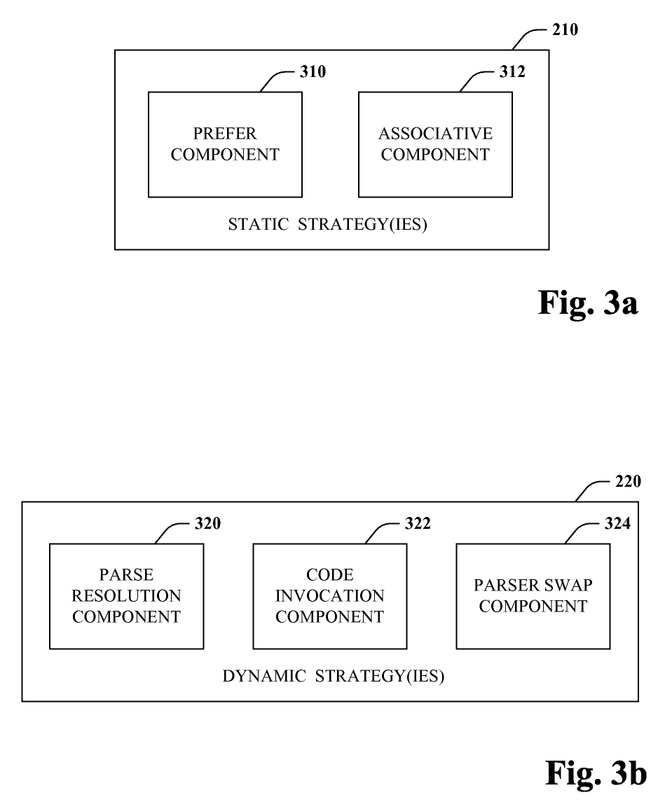

As shown in FIG. 3a, prefer component 310 and associative component 312 are examples of static strategies or subcomponents of static strategies component 210. The prefer component 310 specifies a strategy that prefers one option to another. As previously described one example is a strategy that says prefer a “shift” rather than a “reduce” of an “else” keyword. The associative component 312 can specify operator associativity strategies. In an expression “1+2*3” without specification it may be ambiguous as to whether the addition of “1+2” should occur before or after the multiplication of “2*3”. A conflict resolution strategy can indicate that multiplication should occur first in accordance with standard mathematical order of operations or vice versa.

FIG. 3b depicts exemplary dynamic strategies 220 in accordance with an aspect of the claimed subject matter including parse resolution component 320, code invocation component 322, and parser swap component 324. The parse resolution component 320 employs a strategy that in essence employs parsing system functionality to resolve a conflict. More specifically, when a conflict is encountered a technique such as GLR (Generalized Left-to-Right) parsing can be employed to parse each option and identify the best. Usually only one solution is correct which allows continued parsing all the way through. This usually works but can be potentially inefficient. In simple cases, a static strategy might be more appropriate. By way of example, this strategy can be employed with respect to a comma ambiguity using a command such as but not limited to “% OnConflict ShiftComma, ReduceSomeEnumMemberDeclaration List, Resolve”.

The code invocation component 322 enables execution of some external or outside code, process, or service that can resolve a conflict. In other words, the code provides implementation of the strategy, which can be altered without requiring a change in a parser itself or the original grammar Furthermore, the strategy can actually correspond to another strategy. Accordingly, the strategies are composable.

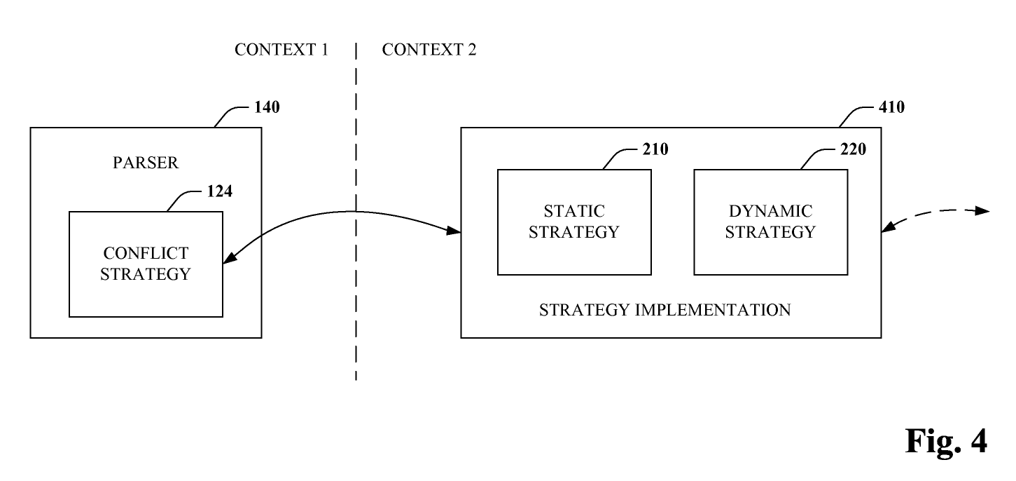

Turning briefly to FIG. 4, the code invocation strategy is graphically illustrated to facilitate clarity and understanding. A parser 140 in a first execution context includes a conflict strategy 124 corresponding to external code invocation. Upon identification of a conflict or ambiguity associated with this strategy, a call can be made to a strategy implementation 410 executing in a second execution context. For example, the strategy can be executed on the same machine as the parser or as a network service, among other things. Moreover, the implementation can correspond to a static strategy 210 or a dynamic strategy 220 as previously described. Thus, code invocation strategy delegates conflict resolution to an external process, service or the like. Moreover, the delegatee can also become the delegator and call another process or service to handle all or a portion of the conflict resolution. In one instance, all conflicts can employ this strategy, which adds a layer of indirection between the parser itself and the conflict resolution. However, this may be inefficient in certain circumstances.

It is noted that by allowing a parser to employ arbitrary code to resolve conflicts, opportunity exists for compromising a parser. To address this issue various interaction protocols can be employed. For instance, the external code can be allowed to return what amounts to a suggestion. In other words, it can simply identify an action to be taken such as a path with which to continue processing. In this manner, control need not be relinquished to the external code thereby reducing the likelihood that the arbitrary code will break or corrupt a parser. Additionally, relevant context information required to resolve a conflict can be provided to external code as a copy or immutable version so that state is not unexpectedly or undesirably altered by the code. Still further yet, the parser can determine acceptable results and compare them to results provided by the arbitrary code to further ensure the code does not misguide the parser. These formalized communication protocols ensure that the parser is generally type safe.

In one implementation, where outside code is to be called to resolve a conflict the following non-limiting command can be provided in the grammar file: “% OnConflict ShiftComa, ReduceVariableInitList Run ShiftCommaOrReduceVAriableInitList”. In this case, the generated parser can have an abstract method that is subsequently overridden and implemented:

abstract ShiftCommaOrReduceVariableInitListResult
ShiftCommaOrReduceVariableInitList(StateStack<INode> stack,
IChain<IToken> input);

Here, the parsing system also generates an enumerator list or set of named constants specifying only meaningful choices for the conflict in question.

```
enum ShiftCommaOrReduceVariableInitListResult
{
    ShiftComma = 32087,
    ReduceSomeVariableInitializerList = −32425,
}
```

Further, the outside code does not have access to the internals of the parsing system, but rather is passed copies or immutable versions of relevant state. Together these mechanisms guarantee the outside code cannot break the parser as a whole and must make a valid choice for handling the conflict or ambiguity.

Returning to FIG. 3b, the parser swap component 324 provides a similar yet distinct dynamic strategy with respect to code invocation. In particular, the parser swap component can call out to or invoke another parser to process an ambiguity or conflict. While the current parser may identify a conflict a more powerful or expensive parser may be able to resolve the conflict. Accordingly, when a conflict is detected one strategy can be to transfer control to another parser, which resolves the conflict and then returns control back to the calling parser, for example. Additionally or alternatively, additional mechanisms can be employed such as those described with respect to code invocation to ensure that the second parser does not break the first parser.

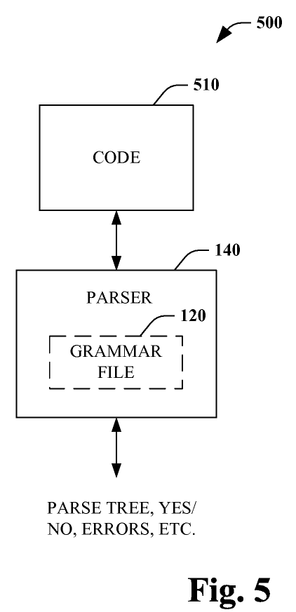

Turning attention to FIG. 5, a parsing system 500 is depicted in accordance with an aspect of the claimed subject matter. The system includes the parser component 140 that processes programmatic code 510. Once the parser is generated by a parser generation system (FIG. 1), parser incorporates the grammar file 120 (or can alternatively reference it). In other words, it captures all grammar production rules as well as ambiguity or conflict resolution strategies. In particular, it can employ a plurality of static and/or dynamic strategies. In operation, the parser can scan and tokenize the code 120 and produce some output. In one instance, that output can correspond to a syntax tree, parse tree, or other internal compiler representation. Additionally or alternatively, it can simply output verification information such an indication of whether or not the code is recognized and is in proper format (e.g., “Yes,” “No”). The parser can also output errors where the code fails to parse completely through. Moreover, at any time where a conflict occurs, the parser 140 can invoke one or more appropriate conflict resolution strategies or options to resolve a conflict or ambiguity.

It should be appreciated that the aforementioned aspects can be employed in different contexts. For example, the aspects can be employed in furtherance of recovering from errors. Fundamentally, a conflict corresponds to an inability to parse due to the lack of a unique processing path. Errors also cannot complete parsing for the same reason. The difference is that with respect to conflicts or ambiguities there is more than one available processing path while with errors there is less than one. However, recovery from an error can correspond to returning from an erroneous path and/or selecting another path that allows parsing, for example, to continue.

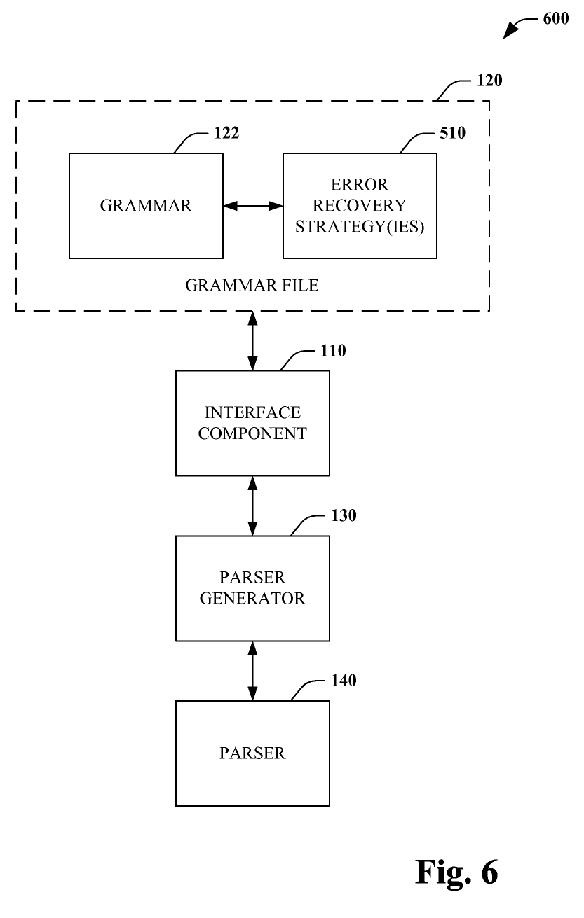

Referring to FIG. 6, a parser generation system is illustrated in accordance with an aspect of the claimed subject matter. Similar to system 100 of FIG. 1, the system 600 includes an interface component to facilitate interaction with the grammar file 120 and the parser generator component 130, which employs the grammar file 120 to produce the parser 140. Here, however, the grammar file 120 can include an error recover strategy component 510 coupled with the grammar 122 rather than or in addition to a conflict resolution strategy component 124 as shown in FIG. 1. The error-recovery strategy component 510 provides numerous strategies to enable error recover including both static and dynamic strategies as previously described. By way of example and not limitation, a code invocation strategy can be provided with respect to one or more errors in which the actual resolution implementation is provided by external code such as a network service that is accessed with precaution to ensure the parsing system is not broken by the external code. The parser generator component 130 captures the grammar 122 and any particular recovery strategies 124 in the parser component 140 for use in program parsing.

Error recover refers to the ability to change the state of a parser in order to continue parsing. In other words, error recovery enables output to be produced, such as a parse tree, among other things, despite the fact that there are errors in a program or program input. A closely related concept is error diagnosis or reporting which concerns production of good error messages for user when errors do occur. Accordingly, error reporting can be coupled to error recover such that upon detection and/or recovery from an error a message can be produced identifying the error.

Further, the disclosed subject matter is not limited to conflict resolution and error recovery. In fact, aspects are applicable to any automation, state machine or like scenarios. By way of example and not limitation, consider workflow systems, which are basically state machines. Conflicts can exist regarding which of several actions to take and strategies can be employed to resolve such conflicts including external code invocation, which can allow dynamic selection of a resolution strategy.

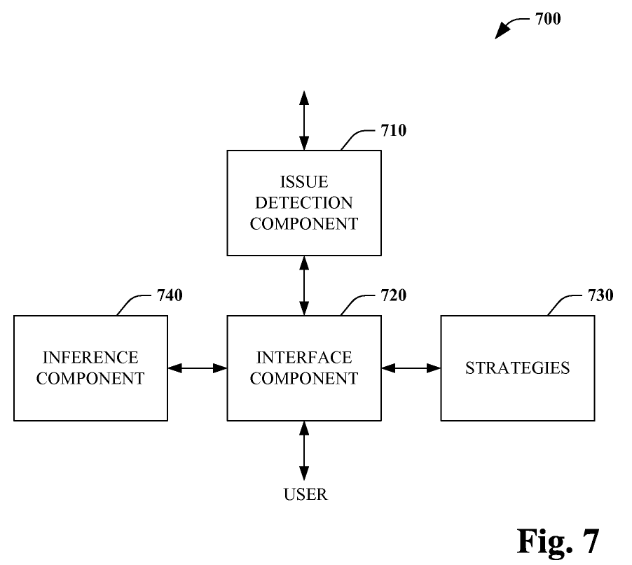

Referring to FIG. 7, a strategy selection system 700 is illustrated in accordance with an aspect of the claimed subject matter. The system includes an issue detection component 710 to identify issues or problems such as but not limited to conflicts and errors. Interface component 720 is a mechanism for presenting information to and acquiring information from users. In particular, upon detection of an issue a plurality of strategies 730 can be identified to a user for selection to address the issue. In one instance, the interface component 720 can order the strategies according to relevancy or effectiveness, among other things in addressing a specific issue. Further inference component 740 can make inferences about which strategy the user should select based on previous selection history with respect to particular issues, and/or user preferences, among other things. Still further yet, it should be appreciated that the interface component 720 can allow selection of available strategies as well as purchase, acquisition and/or employment of other strategies (e.g., plug-in strategies).

The aforementioned systems, architectures, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems above and methods below can include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, various strategies can employ such mechanisms to facilitate conflict resolution and/or error recovery, among other things. Further, the inference component 740 can employ this type of technology to aid a user in identifying a strategy to address some issue such as a conflict or error.

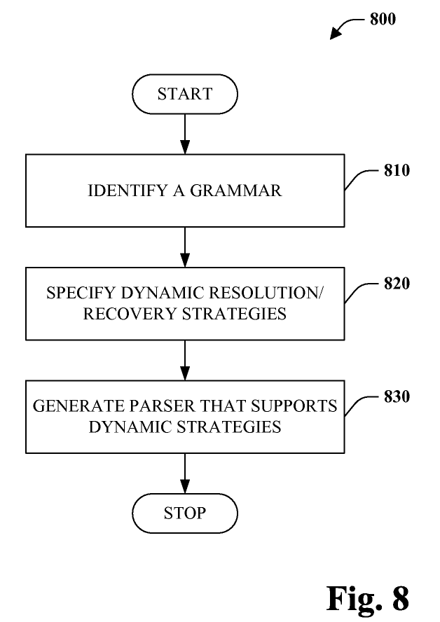

In view of the exemplary systems described supra, methodologies that may be implemented in accordance with the disclosed subject matter will be better appreciated with reference to the flow charts of FIGS. 8-13. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Referring to FIG. 8, a parser generation method 800 is illustrated in accordance with an aspect of the claimed subject matter. At reference numeral 810, a language grammar associated with one or more program languages is identified. At numeral 820, one or more dynamic strategies (e.g., conflict resolution, error recovery . . . ) are specified with respect to the grammar to address conflicts, ambiguities, errors, or the like. Static strategies identify fixed rules, preferences or the like for application whose functionality is predetermined (e.g., pick A over B). Dynamic strategies are much more runtime dependent. In particular, they are more dynamic in their processing and resolution of issues. For example, a strategy that invokes or swaps parsers to resolve a conflict or recover from error is dynamic. Similarly, a strategy is also dynamic where it involves parsing of options and identification of the best path. Further yet, another dynamic strategy can invoke external code including a particular and modifiable strategy implementation.

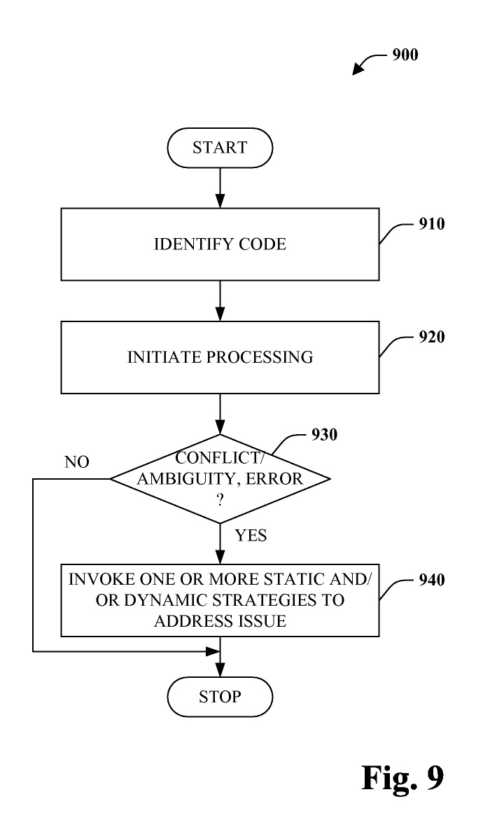

FIG. 9 is a method of code processing in accordance with an aspect of the claimed subject matter. At reference 910, programmatic code designated for processing is identified. At numeral 920, processing is initiated. In one embodiment, processing can correspond to parsing a program although aspects of the claimed subject matter are not limited thereto. At reference 930, a determination is made as to whether a conflict, ambiguity, error or other issue is detected. If not, the method continues processing and terminates. If yes, one or more static and/or dynamic strategies can be employed to address the issue. For example, where a grammar ambiguity prevents parsing based on the grammar alone such strategies can be employed to facilitate parsing.

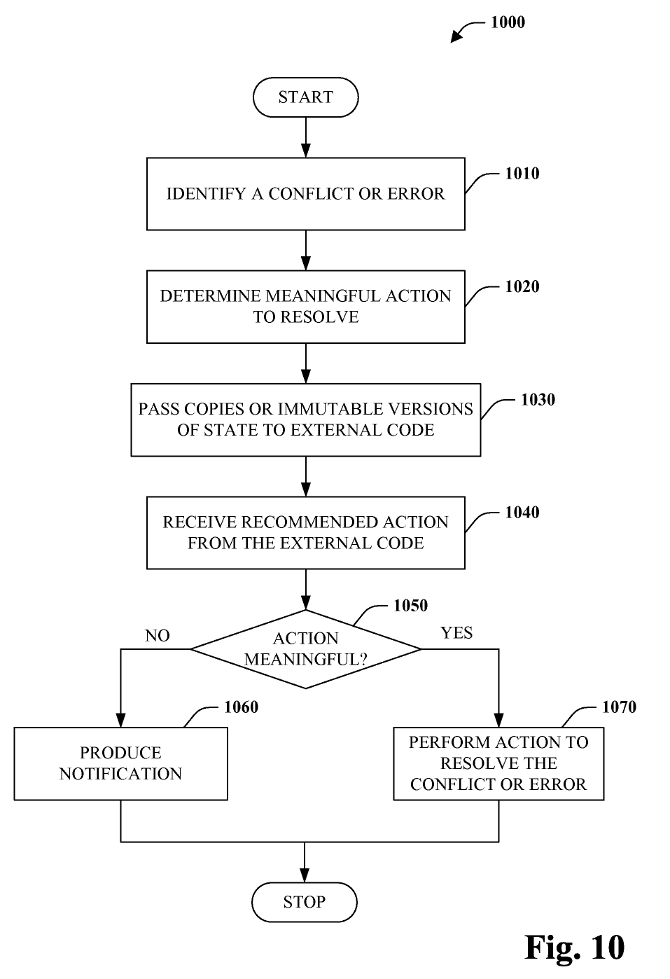

Turning attention to FIG. 10, a method of safe issue resolution utilizing external code 1000 is depicted in accordance with an aspect of the claimed subject matter. For purposes of clarity and not limitation, the method will be described with respect to conflicts or errors although other issues can also be resolved or addressed in a similar manner. At reference numeral 1010, an issue such as a conflict or error is detected, for instance during parsing. At numeral 1020, meaningful actions are determined or otherwise identified that would resolve the conflict or recover from error. At numeral 1030, copies or immutable versions of relevant state are passed to external code or an outside service. This ensures that code has all the information necessary to perform its function while also insulating a calling application from unexpected or undesired alterations of state. At reference, 1040 a recommended action is received from the external code. Rather than allowing the code to perform the action itself, the code simply identifies the action and lets the calling application executed it if it desires yet another layer of insulation. At reference 1050, a determination is made as to whether the action is meaningful as previously determined or otherwise identified. If yes, the action is performed to resolve a conflict or recover from error. If no, a notification or error message can be provided indicating that the code returned a meaningless action.

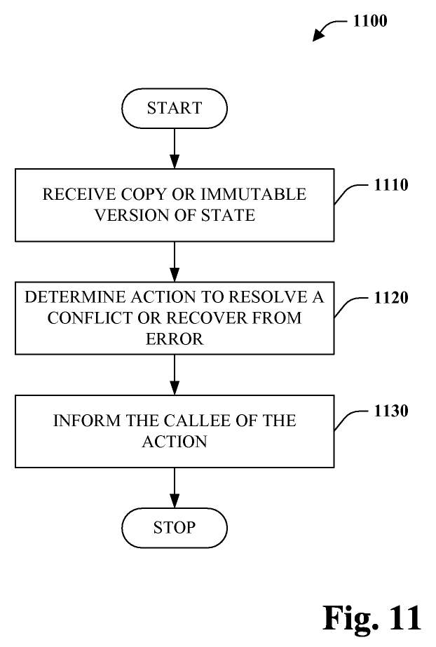

FIG. 11 is a flow chart diagram of an external method of issue resolution 1100 in accordance with an aspect of the claimed subject matter. By way of example and not limitation the method 1100 can correspond to a process, service, or the like outside or external to an application requiring its service. For instance, a parser can employ such a method to resolve conflicts and/or recover from errors. At reference numeral 1110, a copy or immutable version of state is received, retrieved, or otherwise acquired. At reference 1120, an action is determined to an address some issue such as a conflict or error. It is to be noted that all or a portion of the determination can be delegated to yet another process or service. At numeral 1130, a calling entity such as a parser is informed of the action. Of course, where other processes are involved such action could be recursive in nature.

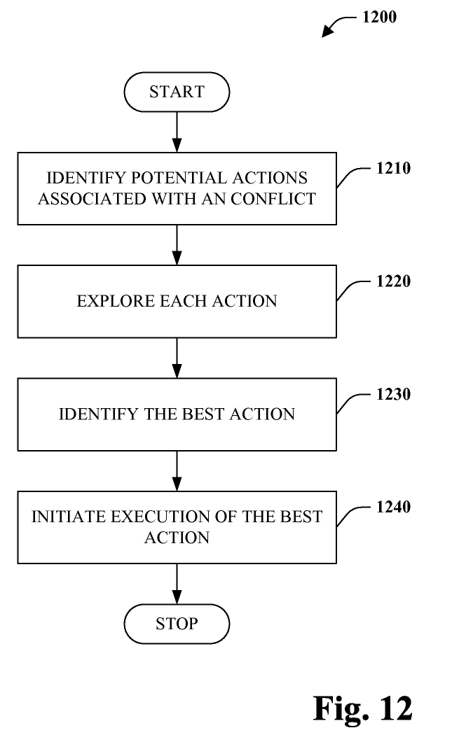

FIG. 12 illustrates a method of conflict resolution utilizing parsing 1200 in accordance with an aspect of the claimed subject matter. Where processing is embodied as parsing, conflicts or ambiguities can be resolved or otherwise addressed by utilizing a parser or parsing system itself to determine the appropriate action. At reference numeral 1210, potential actions or paths are identified with respect to a particular conflict or ambiguity. At numeral 1220, each action is explored by parsing at each potential path. Once each path or action is explored, the best is selected at reference 1230. It is to be appreciated that often one path or action will be the best just as clearly as others will be wrong. For example, one path my allow continued parsing with minimal if any problems while others will generated errors and other conflicts, among other things. At reference numeral 1240, execution of the best or otherwise selected action can be initiated. In other words, a particular path will be selected and followed.

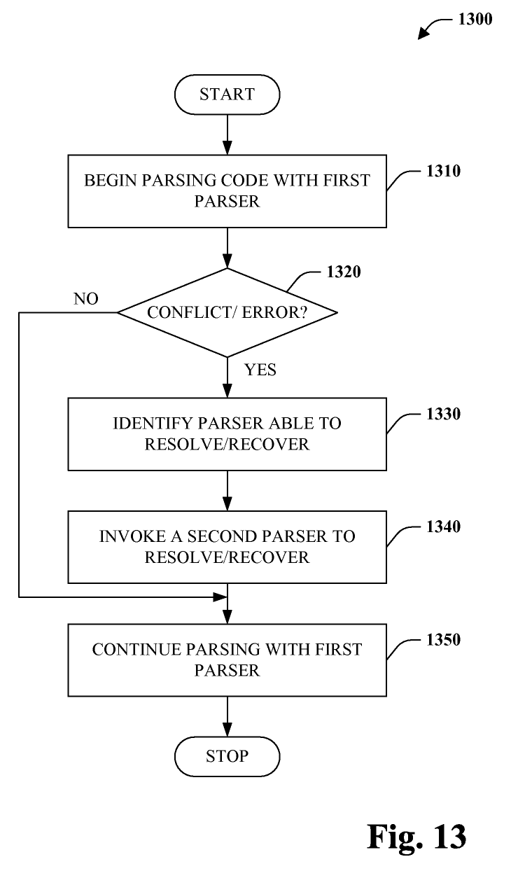

FIG. 13 portrays a conflict resolution/error recovery method 1300 that swaps parsers or other processing mechanisms. At reference numeral 1310, code parsing or other processing is begun. At numeral 1320, a determination is made as to whether a conflict or error is detected during processing. If no, processing continues until finished and the method terminates. Alternatively, if a conflict or error is detected, the method proceeds at reference 1330 where another parser or processing mechanism is identified that is capable of a resolving the conflict or recovery from the error. For example, the current processing mechanism may be a lightweight version of a more comprehensive compiler. Accordingly, the full compiler can be identified for this purpose. At numeral 1340, the other or second parser or mechanism is employed to resolve a conflict/ambiguity and/or recover from an error. In other words, the processing mechanisms can be swapped to enable to leverage the abilities of the second mechanism to overcome the deficiencies of the first. Subsequently, at reference numeral 1350, parsing, or other processing can be continued with the first parser or process mechanism. Here, the parsers are swapped back to the original arrangement.

It is to be appreciated that various examples and discussion supra focus on programmatic code solely for purpose of clarity and understanding. Various systems and methods associated with parsing, conflict resolution, and error recovery can be employed with respect not only to computer or programmatic code but also to natural languages as well as data (e.g., XML (eXtensible Markup Language, JSON (JavaScript Object Notation, comma-separated values . . . )

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated that a myriad of additional or alternate examples of varying scope could have been presented, but have been omitted for purposes of brevity.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the subject innovation.

Furthermore, all or portions of the subject innovation may be implemented as a method, apparatus or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

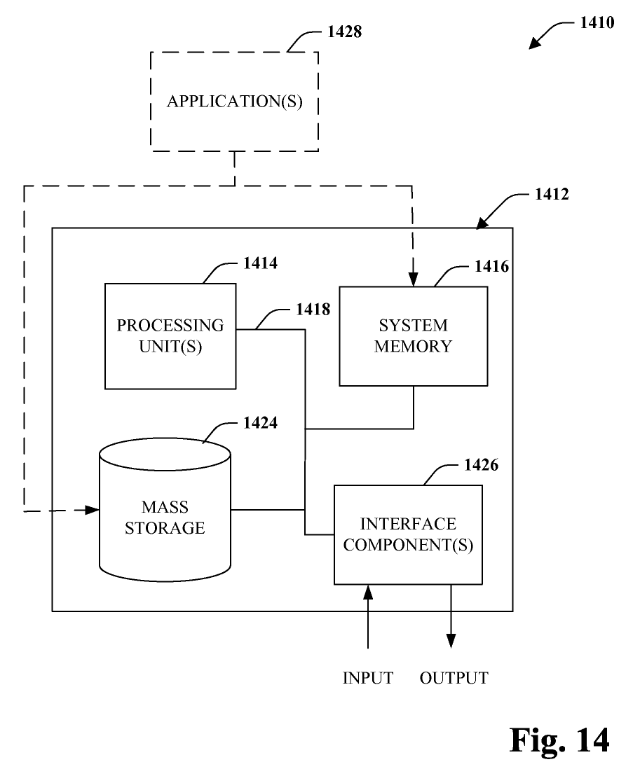

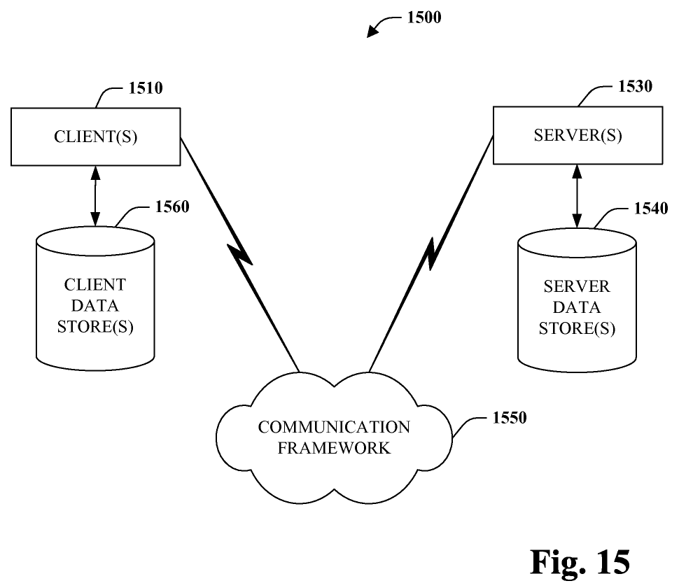

In order to provide a context for the various aspects of the disclosed subject matter, FIGS. 14 and 15 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 14, an exemplary environment 1410 for implementing various aspects disclosed herein includes a computer 1412 (e.g., desktop, laptop, server, hand held, programmable consumer or industrial electronics . . . ). The computer 1412 includes a processing unit 1414, a system memory 1416, and a system bus 1418. The system bus 1418 couples system components including, but not limited to, the system memory 1416 to the processing unit 1414. The processing unit 1414 can be any of various available microprocessors. It is to be appreciated that dual microprocessors, multi-core and other multiprocessor architectures can be employed as the processing unit 1414.

The system memory 1416 includes volatile and nonvolatile memory. The basic input/output system (BIOS), containing the basic routines to transfer information between elements within the computer 1412, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 1412 also includes removable/non-removable, volatile/non-volatile computer storage media. FIG. 14 illustrates, for example, mass storage 1424. Mass storage 1424 includes, but is not limited to, devices like a magnetic or optical disk drive, floppy disk drive, flash memory, or memory stick. In addition, mass storage 1424 can include storage media separately or in combination with other storage media.

FIG. 14 provides software application(s) 1428 that act as an intermediary between users and/or other computers and the basic computer resources described in suitable operating environment 1410. Such software application(s) 1428 include one or both of system and application software. System software can include an operating system, which can be stored on mass storage 1424, that acts to control and allocate resources of the computer system 1412. Application software takes advantage of the management of resources by system software through program modules and data stored on either or both of system memory 1416 and mass storage 1424.

The computer 1412 also includes one or more interface components 1426 that are communicatively coupled to the bus 1418 and facilitate interaction with the computer 1412. By way of example, the interface component 1426 can be a port (e.g., serial, parallel, PCMCIA, USB, FireWire . . . ) or an interface card (e.g., sound, video, network . . . ) or the like. The interface component 1426 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 1412 to output device(s) via interface component 1426. Output devices can include displays (e.g., CRT, LCD, plasma . . . ), speakers, printers and other computers, among other things.

FIG. 15 is a schematic block diagram of a sample-computing environment 1500 with which the subject innovation can interact. The system 1500 includes one or more client(s) 1510. The client(s) 1510 can be hardware and/or software (e.g., threads, processes, computing devices). The system 1500 also includes one or more server(s) 1530. Thus, system 1500 can correspond to a two-tier client server model or a multi-tier model (e.g., client, middle tier server, data server), amongst other models. The server(s) 1530 can also be hardware and/or software (e.g., threads, processes, computing devices). The servers 1530 can house threads to perform transformations by employing the aspects of the subject innovation, for example. One possible communication between a client 1510 and a server 1530 may be in the form of a data packet transmitted between two or more computer processes.

The system 1500 includes a communication framework 1550 that can be employed to facilitate communications between the client(s) 1510 and the server(s) 1530. The client(s) 1510 are operatively connected to one or more client data store(s) 1560 that can be employed to store information local to the client(s) 1510. Similarly, the server(s) 1530 are operatively connected to one or more server data store(s) 1540 that can be employed to store information local to the servers 1530.

Client/server interactions can be utilized with respect with respect to various aspects of the claimed subject matter. By way of example and not limitation, the code invocation strategy can invoke code associated with a network service. For instance, a parser executing on a client 1510 can access a conflict resolution and/or error recovery implementation resident on a server 1530 or another client 1510 across the communication framework 1550. Further, all or a portion of that implementation can delegate functions to other processes or services on yet other clients 1510 and/or servers 1530. Further, components such as the parser generator 130 or parser 140 can be network services.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

What is claimed is:

1. A system to facilitate computer program parsing, comprising:
an interface component that acquires a grammar and one or more conflict resolution and/or error recovery strategies decoupled from the grammar, wherein at least one strategy is dynamic; and
a parser generator component that generates a parser for one or more programming languages as a function of the grammar and the conflict resolution/error recovery strategies.

2. The system of claim 1, one of the strategies invokes user provided code external to the parsing system to identify a conflict resolution or error recovery action.

3. The system of claim 2, the external code delegates at least a portion of functionality to code, a service, or a process external thereto.

4. The system of claim 2, the external code can be changed to effect a different strategy without alteration of the parser.

5. The system of claim 2, the parser generator component inserts an abstract method that can be overridden by an external code implementation.

6. The system of claim 5, the parser generator component inserts parser code to facilitate identification of appropriate resolution or recovery actions.

7. The system of claim 6, the parser generator component inserts code to afford the external code a copy or immutable version of relevant state to ensure system safety

8. The system of claim 1, one of the strategies directs a parser to utilize parsing mechanisms to identify and/or resolve a conflict or recover from an error via exploration of available actions.

9. The system of claim 1, one of the strategies invokes a different parser capable of conflict resolution or error recovery for that purpose.

10. A method of parsing, comprising:
identifying an ambiguity or error in a grammar; and
selecting a strategy from amongst a plurality of static and dynamic strategies capable of resolving the ambiguity or recovering from the error; and
adding appropriate code to a grammar file to effect implementation of the strategy.

11. The method of claim 10, comprising selecting a strategy that instructs a parsing system to employ one or more parsing mechanisms to identify a proper action.

12. The method of claim 10, comprising selecting a strategy that invokes a second parser to determine proper action and returns control back to a first parser.

13. The method of claim 10, comprising selecting a strategy that calls code external to a parsing system to determine appropriate action.

14. The method of claim 13, comprising selecting a strategy in which the action provided by the external code is vetted to ensure it is a valid option for addressing the ambiguity or error.

15. The method of claim 14, further comprising ensuring the external code is unable to alter parsing system state.

16. The method of claim 10, further comprising selecting a second strategy for implementation where a first strategy fails.

17. The method of claim 10, further comprising selecting a strategy from a menu listing the plurality of strategies in accordance with their relevance with respect to a particular ambiguity or error.

18. A method of parsing, comprising:
examining a series of tokens extracted from an input stream;
identifying at least one of a conflict or error in accordance with a grammar;
providing relevant state information to an external service;
acquiring identification of an action from the service; and
performing the action if the action is determined to be meaningful to resolve the conflict or recover from the error.

19. The method of claim 18, further comprising providing a copy or immutable version of the state information to the external to ensure system safety.

20. The method of claim 19, further comprising overriding an abstract parser method of with an external implementation.
